(19) United States
(12) Patent Application Publication
(10) Pub. No.: US 2022/0342043 A1
(43) Pub. Date: Oct. 27, 2022

(54) DEVICE FOR A SATELLITE LASER DISTANCE MEASUREMENT, AND METHOD FOR A SATELLITE LASER DISTANCE MEASUREMENT

(71) Applicant: DEUTSCHES ZENTRUM FÜR LUFT - UND RAUMFAHRT E.V., 51147 Köln (DE)

(72) Inventors: Paul WAGNER, Stuttgart (DE); Daniel HAMPF Daniel HAMPF, Stuttgart (DE)

(73) Assignee: DEUTSCHES ZENTRUM FÜR LUFT - UND RAUMFAHRT E.V., 51147 Köln (DE)

(21) Appl. No.: 17/764,562

(22) PCT Filed: Sep. 23, 2020
(86) PCT No.: PCT/EP2020/076612

§ 371 Date: Mar. 29, 2022

(30) Foreign Application Priority Data
Sep. 30, 2019 (DE) 10 2019 126 336.0

(51) Int. Cl. G01S 7/481; G01S 17/933

(52) U.S. Cl. CPC G01S 7/4813; G01S 17/933

(57) ABSTRACT

A device for a satellite distance measurement includes a base segment and an optical segment which is supported by the base segment and has a telescope mounting with an azimuth axis and an elevation axis, wherein a transmitter telescope, a receiving telescope, and a laser coupled to the transmitter telescope are arranged on the telescope mounting. A method for operating such a device is also provided.

### BACKGROUND AND SUMMARY

The invention relates to a device for satellite laser distance measurement and a method for satellite laser distance measurement.

The technology of satellite laser distance measurement (SLR) has developed from a geodetic tool into a broadly used mission support instrument. There are currently about eight satellite missions relying on continuous laser distance measurement data for obtaining precise position information including several Earth-observing satellites and many navigation satellites. In yet more satellites, SLR measurements were used in the early orbit phase thereof to calibrate or to verify the on-board navigation thereof. In the future, the demand for satellite laser distance measurements could further increase since increasingly more operators of small satellites or even the proposed mega-constellations recognize the potential of this technology for obtaining orbit information, down to the centimeter, during and even after the mission. Only a small and lightweight retroreflector is needed on-board the satellites. A worldwide network of around 40 stations is available for positioning purposes on Earth (International Laser Ranging Service, ILRS).

Currently, the ILRS tracking list contains about 30 missions in low Earth orbit (LEO) and about 50 targets in high Earth orbits of 19,000 to 24,000 km in altitude, usually GNSS satellites (Global Navigation Satellite System). Typically, a good SLR station today achieves an accuracy of about 1 cm in the distance measurement and is capable of working day and night.

However, many of the existing ILRS stations are reaching their limits with respect to the number of observed satellites. Moreover, the worldwide coverage is somewhat inhomogeneous, with many stations in Europe and Asia, only a few in Africa and America, and none in very high northern and southern latitudes. A few new stations are under construction while others are in the planning stage worldwide. These stations are integrated into their own buildings, which often include an observatory and adjoining laboratory rooms. Both the investments for construction and the installations as well as the operating costs are significant and represent a serious obstacle for expanding the network.

The publication from F. Pierron et al. “Status and new Capabilities of the French Transportable Laser Ranging Station,” Proceedings of the 11th International Workshop on Laser Ranging, Deggendorf, Germany, 21-25 Sep. 1998, describes a transportable system with a total weight of 300 kg in eight containers.

It is desirable to obtain an economical device for satellite laser distance measurement.

It is also desirable to provide a method for operating such a device.

A device for satellite laser distance measurement is proposed having a base segment and an optical segment, which is supported by the base segment. The optical segment has a telescope mounting with an azimuth axis and an elevation axis. A transmitter telescope, a receiving telescope, and a laser coupled to the transmitter telescope are arranged on the telescope mounting.

The receiving telescope may be, for example, a Newtonian telescope with an aperture diameter of 20 cm.

Due to the arrangement of the laser on the telescope mounting, the beam guide can be provided between the laser and the transmitter telescope, outside of the axes of rotation. By virtue of this arrangement of the laser on the telescope mounting, an expensive and complex Coudé beam guide, in which a beam guide for the laser beam must be guided through the axes of rotation of the telescope mounting, is not necessary. Thus, the size and weight of the telescope mounting as well as the overall design can be reduced significantly. The costs for such a device can be reduced considerably since a customary telescope mounting can be used.

Small, powerful, and robust lasers make it possible to place the laser on the telescope mounting. Lasers with relatively low pulse energies and high repetition rates can be used, which are smaller and more economical, with an equivalent average performance, than the high-energy lasers typically used in satellite distance measurement.

Advantageously, the device can be designed as transportable. The dimensions and the weight make it possible to produce the device at one location and transport it to another location. Therefore, operating the telescope mounting on a base, which is otherwise customary, can be omitted. Instead, any technological equipment of the device can be mounted in the transportable device. Any inaccuracies resulting therefrom can be compensated by a suitable method, such as so-called closed-looped tracking and the creation of a so-called pointing model.

The device can be constructed in modules in order to fulfill customer-specific requirements. The complete device can contain only a minimal set of easily replaceable components so that on-site maintenance is facilitated. The components used in the device are advantageously commercially available components. The device can be adapted to different requirements with practically no further development expense.

The entire structure, including all the control and data acquisition electronics, can be housed in a small container, for example an aluminum container. Favorable dimensions are, for example, 1.80 m×1.20 m×1.60 m.

The base segment supports the telescope mounting and is accordingly designed to be stable and torsion-resistant. The control electronics and control computer can be protected from weather influences and temperature-controlled or climate-controlled.

Advantageously, the control software can be designed to operate the device almost completely automatically, particularly the control of the hardware components in the device. This enables the device to implement all process steps itself including everything from the recording of weather conditions to measurement planning, actuation of the telescope mounting, recording of images, actuation of the laser, the beam alignment, recording of distance data, and evaluation of distance data and images. This can advantageously reduce the operating and maintenance costs. Furthermore, corrections with the pointing model or the closed-loop tracking can be implemented automatically.

According to an advantageous embodiment of the device, the telescope mounting may have a swivel base with the azimuth axis and a rotary shaft with the elevation axis, about which the telescopes can be swiveled synchronously with one another, and the laser can be swiveled synchronously with the transmitter telescope. Therefore, the laser can advantageously be arranged on the counterbalance axis of the receiving telescope, namely the elevation axis, whereby the telescope mounting can be balanced according to weight.

Advantageously, objects such as satellites and missile bodies can be equipped with small retroreflectors. Such reflectors are generally less than 20 mm×20 mm, weigh only a few grams, and do not require any energy. The distance measurement to these objects can be a routine task for any existing or future SLR station by means of the device according to the invention. The distance to a satellite can be determined with an accuracy in the centimeter range, and its trajectory can normally be predicted with uncertainties of a few meters.

In addition, when several retroreflectors are used, the alignment of the satellite can be determined with a resolution down to 1°. During the service life of a mission, it can support many position-sensitive tasks which could otherwise require difficult, bulky, and energy-intensive on-board position sensors.

According to an advantageous embodiment of the device, a carrier plate of a support unit can extend between the two telescopes, some distance apart from the elevation axis. In particular, the support unit may comprise the carrier plate, which is arranged parallel to the elevation axis, as well as at least one further carrier plate, which is arranged parallel to the azimuth axis. The two carrier plates can be advantageously rigidly connected to one another, particularly via one or more bracket elements. The transmitter telescope and the further carrier plate can be connected to one another. The rigid support unit stabilizes the structure on the telescope mounting and provides stable positioning of the components. Advantageously, the carrier plates can be designed as a type of plugboard, also known as a breadboard. This makes possible a flexible arrangement and alignment of the components on the respective carrier plate as well as modularization.

According to an advantageous embodiment of the device, the telescope mounting may have an optical transmitter coupled to the transmitter telescope and an optical receiver coupled to the receiving telescope. In particular, the optical transmitter can be attached to the one carrier plate and the optical receiver can be attached to the other carrier plate. This facilitates the modular structure of the device.

According to an advantageous embodiment of the device, the optical transmitter may comprise one or more of the following components: (i) a laser energy regulation unit, particularly with a beam attenuation unit; (ii) a laser energy control unit, particularly with a beam splitter and/or a measuring head for energy and/or power; (iii) an aperture, particularly a mechanical aperture; (iv) a variable beam expansion unit; (v) a beam direction regulation unit, particularly a movable mirror; (vi) a beam splitter; (vii) a transmitter camera, particularly a transmitter camera with image-generating optics; (viii) a starter diode; (ix) at least one mirror; and (x) at least one retroreflector.

The components can be compactly mounted on one of the carrier plates of the support unit. The optical transmitter is used for expansion and collimation of the laser beam. A diameter of at least 30 mm, for example no more than 100 mm, is advantageous. Furthermore, energy regulation and control of the laser pulse energy can also take place.

According to an advantageous embodiment of the device, the optical receiver may comprise one or more of the following components: (i) a beam splitter for splitting the radiation received by the receiving telescope into visible light and infrared light; (ii) a tracking camera in the focus of the receiving telescope; (iii) an optical relay unit, which is provided as further imaging optics; (iv) a bandpass filter; (v) a detector and/or an optical fiber for supplying the received signals.

The radiation received by the receiving telescope can be split into the visible spectrum and the infrared spectrum in the optical receiver.

According to an advantageous embodiment of the device, the laser can have radiation in the near-infrared range (NIR), particularly IR-B with a wavelength between 1500 nm and 1750 nm. In particular, the laser can be assigned to laser class I according to DIN EN 60825-1 from 2004, according to which the accessible laser radiation is safe under reasonably foreseeable conditions, particularly safe for the eyes, as long as the cross-section is not reduced by optical instruments (magnifiers, lenses, telescopes). Thus, the device can be set up at any public locations without restrictions regarding this.

According to an advantageous embodiment of the device, the laser can have laser pulses with a pulse length from the picosecond range to the nanosecond range, particularly in the range of 0.5 picoseconds to 100 ns, with a pulse energy of 1 μJ to 1 mJ. Diode-pumped solid state lasers are advantageous.

A high pulse repetition frequency is advantageous in order to enable the recording of many measured values. A pulse repetition frequency very much greater than 10 kHz, particularly greater than 30 kHz, is advantageous.

According to an advantageous embodiment of the device, the base segment may comprise one or more of the following components: (i) a control computer; (ii) control electronics, particularly with an event timer and a trigger generator.

Advantageously, the control computer can control any hardware, such as lasers, telescope mounting, cameras, detectors, sensors, laser beam direction, and laser energy. Advantageously, the control computer has a network connection for remote control of the device.

According to an advantageous embodiment of the device, the optical segment may have at least one cover. In particular, the transmitter telescope, the receiving telescope, and the support unit may have separate covers. A separate cover for the telescopes and the support unit reduces contamination of the components in the event that individual components must be exposed for maintenance purposes.

According to an advantageous embodiment of the device, an interior of the at least one cover of the optical segment may be climate-controlled. In particular, a climate-control unit may be arranged in the base segment. Problems with humidity or great temperature fluctuations can be prevented.

According to a further aspect of the invention, a method is proposed for operating a device according to the invention. The method can be used with a device for satellite laser distance measurement. The device comprises a base segment and an optical segment supported by the base segment, which has a telescope mounting, with an azimuth axis and elevation axis, with a transmitter telescope and a receiving telescope as well as a laser coupled to the transmitter telescope being arranged on the telescope mounting. In this case, upon a movement of the transmitter telescope, the laser also moves synchronously with the transmitter telescope.

The synchronous movement of the laser with the transmitter telescope enables a stable transmission of the laser pulse without complex variable beam guidance. The weight and installation space of the device can thereby be reduced. In addition, the incidence of errors in the system can be reduced in this manner.

According to an advantageous embodiment of the method, a distance measurement of an object can take place with the following steps: (i) calibrating a tracking camera of the optical receiver; (ii) measuring the position of the object to be measured on the camera image of the tracking camera; (iii) aligning the telescope mounting by means of coordinates converted from measurement of the image; (iv) repeating steps (ii) and (iii) as long as the converted coordinates have a predetermined deviation from a target position. This procedure provides a very precise alignment of the receiving telescope onto the object to be measured in an advantageous manner.

According to an advantageous embodiment of the method, an alignment of a laser beam onto an object can take place with the following steps: (i) checking the focus of the transmitter camera onto the laser beam and determining the focus position, in the transmitter camera, of the laser beam reflected back by a retroreflector; (ii) determining a motor position in relation to the focus position; (iii) observing a position of at least one object and determining the object position of the depicted object in the transmitter camera after removal of the retroreflector and temporary blocking of the laser beam; (iv) converting the object position into the motor position. Advantageously, it can thusly be determined which motor position correlates with which camera position.

When checking the focus of the transmitter camera, at least one retroreflector is placed in front of the output aperture of the transmitter telescope and removed after the calibration procedure.

According to an advantageous embodiment of the method, an object distance can be determined with the following steps: (i) determining a point in time of an emission of a laser pulse onto an object by means of an event timer; (ii) determining a point in time, by means of an assigned detector, upon detection of a photon, particularly of the laser pulse being reflected back from the object to be measured; (iii) transferring the points in time to an evaluation unit, particularly a control computer; (iv) correlating the measured values of emission and detection. In this manner, an object distance can be determined with great accuracy.

According to an advantageous embodiment of the method, data evaluation can be determined with the following steps: (i) calibrating the device by means of measuring the distance from an object with a known distance; (ii) correlating points in time of the emission of laser pulses and of the receipt of signals; (iii) comparing an expected delay time to an object to be examined to a delay time measured thereon; (iv) extracting correlated data; (v) averaging the distance measurements on the object to be examined. In this manner, an object distance can be determined with great accuracy.

Control software may be capable of receiving data in a completely automated manner. This includes any control of the hardware components in the system. This enables the system to implement all process steps itself, including everything from the recording of the weather conditions to measurement planning, actuation of the mounting, recording of images, actuation of the laser, the beam alignment, the recording of distance data, and the evaluation of distance data and images, such that no further operation is necessary. Possible corrections with the pointing model or the closed-loop tracking can likewise be implemented automatically.

The control software can be constructed in modules and use open source software, to the extent possible. This makes it possible for any users to expand the system themselves according to their requirements.

### BRIEF DESCRIPTION OF THE DRAWINGS

Further advantages result from the following description of figures. Exemplary embodiments of the invention are shown in the figures. The figures, the description, and the claims contain numerous features in combination. One of ordinary skill in the art will expediently also consider the features individually and combine them into other reasonable combinations.

FIG. 1 a schematic structure of components of an optical transmitter of a device for satellite laser distance measurement according to an exemplary embodiment of the invention;

FIG. 2 a schematic structure of components of an optical receiver of a device for satellite laser distance measurement according to an exemplary embodiment of the invention;

FIG. 3 a schematic lateral view of a device for satellite laser distance measurement according to an exemplary embodiment of the invention;

FIG. 4 a plan view of the optical transmitter of the device for satellite laser distance measurement according to FIG. 3;

FIG. 5 a plan view of the optical receiver as well as the laser of the device for distance measurement according to FIG. 3;

FIG. 6 an isometric representation of the optical receiver with the telescope mounting;

FIG. 7 an isometric representation of the device for satellite laser distance measurement according to FIG. 3 with cover;

FIG. 8 an isometric representation of the optical transmitter and optical receiver with telescope mounting according to another exemplary embodiment of the invention;

FIG. 9 a flowchart of a method for distance measurement of an object according to an exemplary embodiment of the invention;

FIG. 10 a flowchart of a method for aligning a laser beam onto an object according to an exemplary embodiment of the invention;

FIG. 11 a flowchart of a method for determining an object distance according to an exemplary embodiment of the invention; and

FIG. 12 a flowchart of a method for data evaluation according to an exemplary embodiment of the invention.

### DETAILED DESCRIPTION

Similar or equivalently-functioning components have the same reference numbers in the figures. The figures merely show examples and should not be considered restrictive.

Direction terminology used in the following with terms such as “left,” “right,” “upper,” “lower,” “in front of,” “behind,” “thereafter,” and the like are only used for better understanding of the figures and should not represent, in any case, a restriction of generality. The components and elements shown and the configuration and use thereof may vary with respect to the considerations of one skilled in the art and can be adapted to the respective applications.

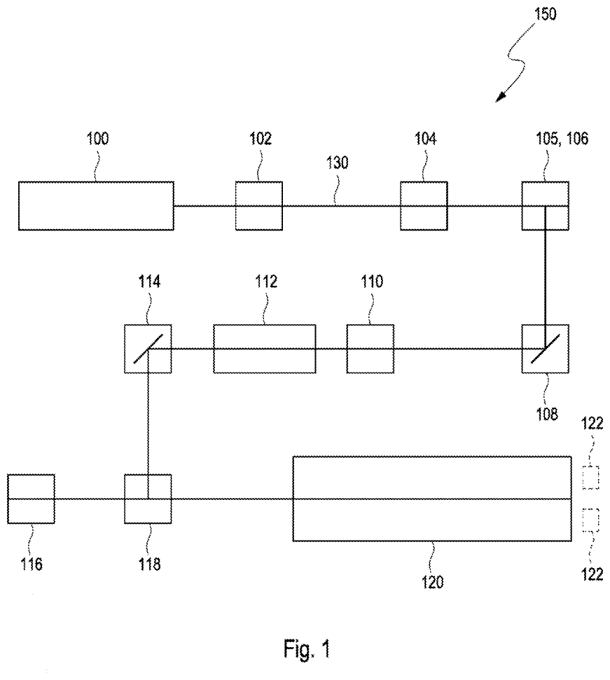

FIG. 1 shows a schematic structure of components of an optical transmitter 150 of a device 500 for satellite laser distance measurement according to an exemplary embodiment of the invention. The device may advantageously be mobile and suitable for transport on roadways.

The optical transmitter 150 consists of or comprises the laser 100 as the actual laser radiation source, the transmitter unit with various components for beam expansion, and the transmitter telescope 120 as a final beam expansion unit. A pulsed laser beam is generated in the laser 100, which laser beam can be collimated via an optional laser collimator.

Advantageous lasers 100 have a laser pulse with a pulse length in the picosecond to nanosecond range, particularly in the range of 0.5 picoseconds to 100 nanoseconds, with a pulse energy of 1 μJ bis 1 mJ and with a wavelength between 1500 nm and 1750 nm. A high pulse repetition frequency is advantageous in order to enable the recording of many measured values. A pulse repetition frequency very much greater than 10 kHz, particularly greater than 30 kHz, is advantageous.

Suitable, commercially available lasers include, for example, pulsed erbium-doped fiber lasers with a central wavelength of 1550 nm and pulse energies of up to 50 mJ, which can be obtained from the IPG Photonics Corporation, Oxford, Mass., USA, under the name ELPN 1550, with pulse lengths from 1 to 100 ns and pulse repetition rates in the range of 10 kHz to 100 MHz. Furthermore, a pulsed erbium laser in the same wavelength range is available under the name ELPF-10-500-10-R having a pulse energy of up to 10 μJ, pulse lengths of 500 ns, and pulse repetition rates in the range of 100 kHz to 2 MHz.

The optical transmitter 150 is used to expand and collimate the laser beam, preferably down to less than 100 mm diameter. Furthermore, the optical transmitter 150 is used for energy regulation and control of the laser pulse energy as well as for beam direction regulation and control of the laser beam direction. The optical axis of the transmitter telescope 120 in this case should be arranged as parallel as possible to the optical axis of the receiving telescope 200.

Adjacent the laser 100, a starter diode 102 is arranged, which detects a rising edge of the laser pulse and forwards this to an event timer of the control electronics 514 of the device 500. The distance from the object can be determined by comparing the edges of emitted laser pulses and the edges of laser pulses radiated on an object to be tracked, for example a satellite. The starter diode 102 only has to receive a very small portion of the laser light for pulse detection; therefore, scattered light or transmission from an imperfect mirror is sufficient. Expediently, the diode should always receive the same pulse energy.

Suitable, commercially available event timers can be obtained, for example, from PicoQuant GmbH, Berlin, Germany. Trigger pulse widths of 0.5 to 30 ns having a rising edge of no more than 2 ns can be processed with a device of the name HydraHarp 400. The temporal accuracy achieved in this case is less than 12 ps rms. The maximum count rate is 12.5×10⁶ event/s.

The laser beam then passes through a laser energy regulation unit 104 in which the laser beam energy is regulated via a beam attenuation unit, which can preferably be designed reflectively. Advantageously, a notch filter can be used in a filter wheel driven by an electric motor to implement this.

Subsequently, the energy of the laser beam is measured in a laser energy control unit 106, which has a measuring head for energy or power. The laser pulse is decoupled into the laser energy control unit 106 via a beam splitter 105, for example formed as a 90:10 or 99:01 beam splitter.

Using a mirror 108, the laser beam is directed into an aperture 110, for example a mechanical aperture 110, by means of which the laser beam can be disrupted.

A beam expansion and focusing unit 112 subsequently follows this as an option. The beam expansion unit 112, for example, is an afocal, optical system, which has a collimated bundle of rays as an input and output. The diameter and angle ratio of the laser beam can thereby be modified and, in doing so, determined from the enlargement of the optical system.

The laser beam direction can be set electronically by means of a downstream movable mirror 114, which can be adjusted with a motor via two axes which are perpendicular to one another.

The IR/VIS beam splitter 118 downstream thereof can split radiation into the infrared spectrum, which is used for distance determination, and radiation in the visible spectrum. The infrared laser light emitted is routed, via the beam splitter 118, into the transmitter telescope 120 for the final beam expansion. The transmitter telescope 120 generates images into infinity.

Incident, visible light can be routed from the transmitter telescope 120 into the transmitter camera 116 via the beam splitter 118. The transmitter camera 116 with its image-generating optical system is focused on the laser wavelength. The image sensor is arranged in the focal point of the optical system.

Retroreflectors 122 may be temporarily arranged in front of the exit aperture of the transmitter telescope 120. The laser light is reflected back into the same direction. By means of the imperfect IR/VIS beam splitter 118, sufficient light reaches the transmitter camera 116, onto which the laser beam is focused. Several retroreflectors 122 or movements of the retroreflector 122 perpendicular to the optical axis make it possible to check whether the transmitter camera 116 is focused on the laser light. The beam is always focused as a point at the same position on the transmitter camera 116 and must not move. Upon a change in the beam direction due to the movable mirror 114, it can then be determined which beam direction corresponds to which focus position on the transmitter camera 116.

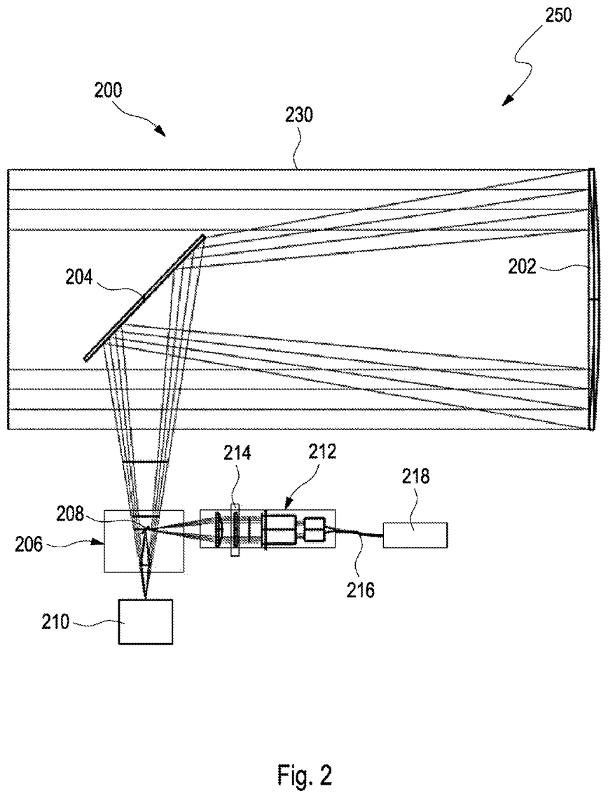

FIG. 2 shows a schematic structure of components of an optical receiver 250 of a particularly mobile device 500 for satellite laser distance measurement according to an exemplary embodiment of the invention.

Incident light 230, which comprises both the back-scattered laser beam as well as visible light from the object which is emitted by the sun, is directed, by means of the receiving telescope 200, onto an IR/VIS beam splitter 206, which permits passage of the visible spectrum, via the image-generating optical receiver, for example the concavely curved primary mirror 202, which can be particularly designed as a spherical or parabolic curve, and the output mirror 204. The receiving telescope 200 is formed as the image-generating system.

The visible light is directed onto a tracking camera 210, which is arranged in the focus of the receiving telescope 200. The tracking camera to 210 in this case captures the object to be measured and measures the position thereof as relates to the optical axis of the receiving telescope 200.

A suitable, commercially available tracking camera is sold, for example, by Oxford Instruments Gruppe under the name ZYLA 5.5. The camera has a 2560×2160 (5.5 megapixel) CMOS sensor and works at read-out rates of up to 560 MHz.

The infrared portion of the incident light is directed into an optical relay unit 212 via the beam splitter 206, which optical relay unit implements a second optical image-generation in order to make the field of vision in front of the following detector 218 as large as possible. The optical relay unit 212 in this case can focus the incident light directly onto the detector 218 when it is connected directly. Alternatively, the optical relay unit 212 can introduce the incident light into an optical fiber 216, which then, in turn, directs the light into the detector 218.

Expediently, a bandpass filter 214 may be arranged in the optical relay unit 212. In order to filter out undesired radiation, the bandpass filter 214 can be designed such that it only allows through the spectral range emitted by the laser and blocks other ranges to the extent possible. This filtering can be also carried out, for example, in several steps.

The detector 218 may advantageously be formed as a single-photon detector and used to detect the received laser pulse.

Suitable, commercially available detectors are NIR single-photon detectors for the wavelength range of 900 to 1700 nm, which are sold, for example, under the name SPD_A_NIR by Aurea Technology SAS, Besançon, France.

Further suitable, commercially available detectors are nanowire detectors, which are sold, for example, by ID Quantique SA, Geneva, Switzerland, under the name ID281 and which work in the wavelength range of 780 to 1625 nm and have detection rates of up to 50 MHz.

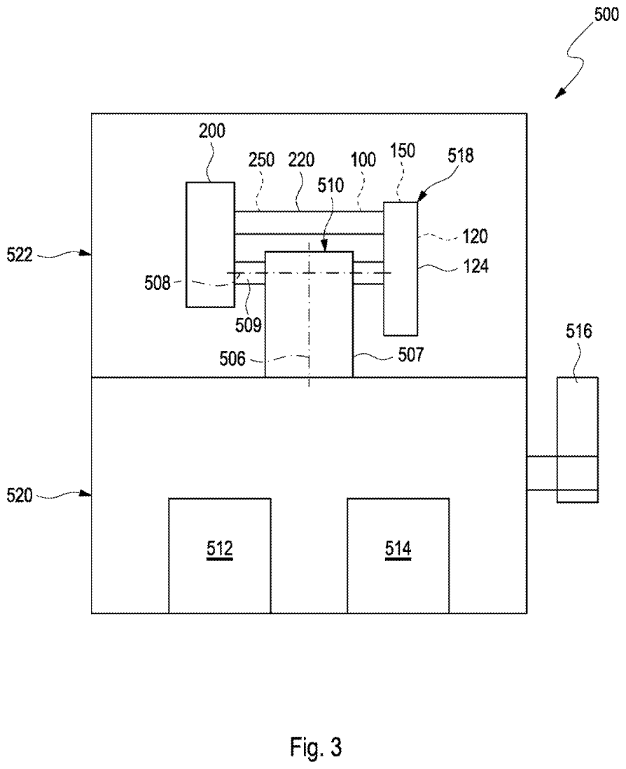

FIG. 3 shows a schematic lateral view of a particularly mobile device 500 for satellite laser distance measurement according to an exemplary embodiment of the invention.

The fundamental structure of the device 500 has a base segment 520, which supports an optical segment 522 with the telescope mounting 510 and therefore is formed to be sufficiently stable and torsion-resistant. Furthermore, the control electronics 514 and the control computer 512 are arranged in the base segment 520, which control electronics and control computer are protected from weather influences in the base segment 520. Optionally, the interior of the base segment 520 can be temperature-controlled and/or climate-controlled.

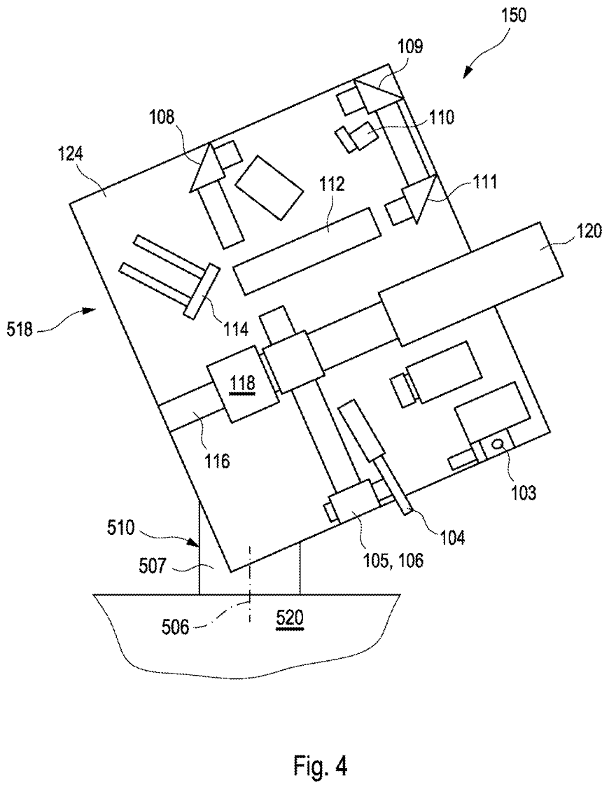

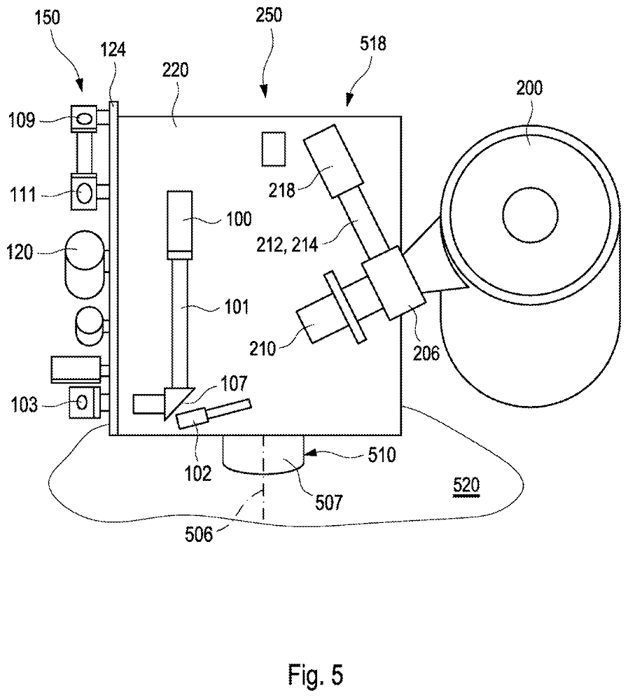

The telescope mounting 510 has two motorized axes perpendicular to one another, namely a swivel base 507 for the azimuth axis 506 and a rotary shaft 509 for the elevation axis 508, and this makes it possible to implement the alignment of the transmitter telescope 120 and receiving telescope 200 in an electronically controlled manner via the complete half-space of the sky. The telescope mounting 510 supports the optical receiver 250, the laser 100, the receiving telescope 200, the optical transmitter 150, and the transmitter telescope 120. The components are mounted on carrier plates 124, 220 of a support unit 518, which is mounted at the rotary shaft 509 representing the elevation axis 508. The carrier plates 124, 220 are shown with the corresponding components in FIGS. 4 and 5.

The support unit 518 comprises the carrier plate 124, which is arranged parallel to the elevation axis 508, as well as at least one further carrier plate 220, which is arranged parallel to the azimuth axis 506, in which the two carrier plates 124, 220 are rigidly connected to each other. In particular, the transmitter telescope 120 and the further carrier plate 220 are connected to one another in this case.

The base segment 520 further has an antenna mount 516, on which sensors and antennas are arranged. For example, a weather station may be provided having sensors for clouds, pressure, air humidity, and temperature. Furthermore, a GPS antennae (GPS=Global Positioning System) and optionally an ADSB antenna (ADSB=Automatic Dependent Surveillance-Broadcast) and/or a mobile communications antenna, for example according to the LTE standard (LTE=Long-Term Evolution), may be provided for remote control of the device 500.

The optical segment 522 is provided to protect the components on the telescope mounting from environmental influences as well as to optionally provide climate control. The optical segment 522 may have, for example, a viewing window so that light can reach the receiving telescope 200 and light from the transmitter telescope 120 can be radiated and received. The optical segment 522 can be designed as one part that protects all components or designed in several parts such that the receiving telescope 200, the optical transmitter 150, and optical receiver 250 can be housed and climate-controlled separately.

The control computer 512 controls hardware components such as the laser 100, the telescope mounting 510, the tracking camera 210, detectors 218, sensors, laser beam direction, and laser beam energy and may have a network connection for remote control.

The control electronics 514 have, for example, GPS-synchronized time servers. The control electronics 514 comprise the event timer, which is synchronized with a clock rate of 10 MHz via highly precise GPS signals that are available via the PPS (Precise Positioning Service) class, and record the time of an event, triggered by the starter diode 102 and the single-photon detector 218. The control electronics 514 may further optionally comprise an LTE router for remote control and a trigger generator for controlling the laser pulse emission and the single-photon detector.

Suitable, commercially available reference units for time and frequency synchronization on the basis of GPS signals are sold, for example, by Meinberg Funkuhren, Bad Pyrmont, Germany, under the name RD/GPS.

FIG. 4 shows a plan view of the optical transmitter 150 of the particularly mobile device 500 for satellite laser distance measurement according to FIG. 3.

The components shown in FIG. 1 are arranged on the carrier plate 124 of the optical transmitter 150 in a modular and space-saving manner. The laser beam is coupled in via mirror 103 and forwarded to mirror 108 via the laser energy regulation unit 104, the beam splitter 105, and the laser energy control unit 106. From there, the laser beam continues, via the aperture 110, to mirrors 109, 111 and is directed to the movable mirror 114 via an optional, variable beam expansion unit 112. From there, the laser beam reaches the transmitter telescope 120 via the beam splitter 118 or the transmitter camera 116.

FIG. 5 shows a plan view of the optical receiver 250 and the laser 100 of the particularly mobile device 500 for satellite laser distance measurement according to FIG. 3.

The receiving telescope 200 with covered aperture is mounted on the end face of the carrier plate 220, which end face is on the right in the viewing direction. The light received by the receiving telescope 200 reaches the beam splitter 206, the visible spectrum of which is directed into the tracking camera 210, while the infrared spectrum is directed into the detector 218 via the optical relay unit 212 with an optional bandpass filter 214.

Furthermore, the laser 100 is mounted on the carrier plate 220, the laser light of which laser is directed into the optical transmitter 150, via the laser collimator 101 and the mirrors 107, 103, which are mounted on the carrier plate 124 arranged perpendicular thereto.

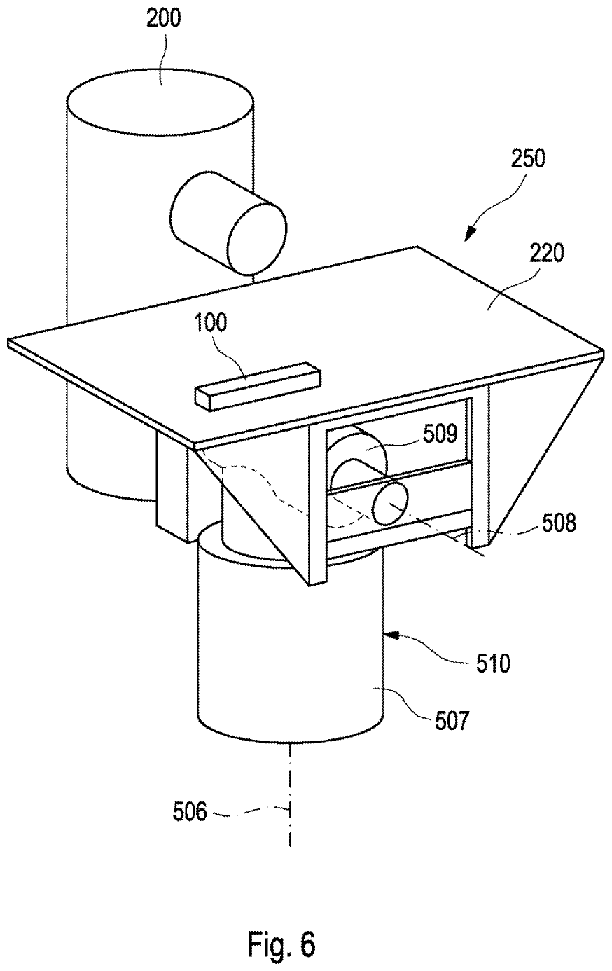

FIG. 6 shows an isometric representation of the optical receiver 250 with the telescope mounting 510 shown separately. This clearly shows the arrangement of the carrier plate 220 with the receiving telescope 200 mounted on the side on the rotary shaft 509 of the telescope mounting 510.

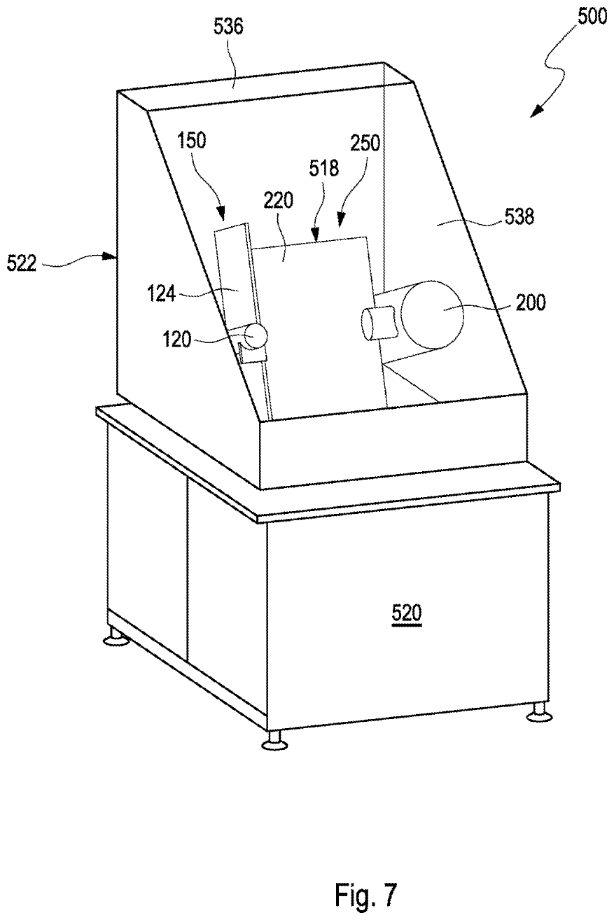

FIG. 7 shows an isometric representation of the device 500 for satellite laser distance measurement according to FIG. 3 with a cover 536. The cover 536 arranged on the optical segment 522 has a viewing window 538, through which the laser light can be emitted and received.

FIG. 8 shows an isometric representation of the optical transmitter 150 and optical receiver 250 with the telescope mounting 510 according to another exemplary embodiment of the invention. The arrangement of the individual components arranged on carrier plates 124 and 220, the transmitter telescope 120, the optical transmitter 150, the optical receiver 250, as well as the receiving telescope 200 corresponds to the previously shown arrangement on the telescope mounting 510. In addition, this embodiment has covers 530, 532, 534, which protect the individual components from mechanical damage, weather influences, and scattered light of the laser radiation and can additionally provide temperature control as needed. The cover 534 of the optical transmitter 150 is shown open on the side opposite the carrier plate 124, but it can also be closed.

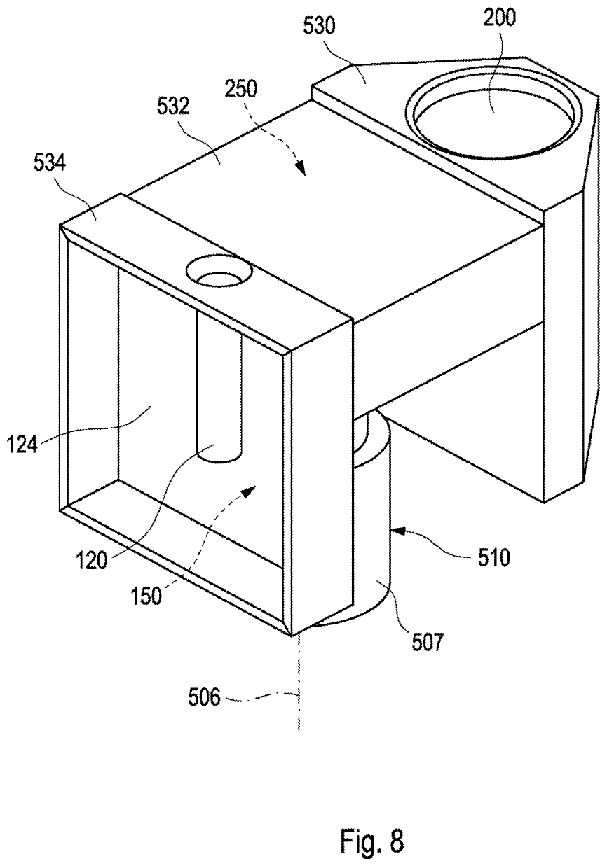

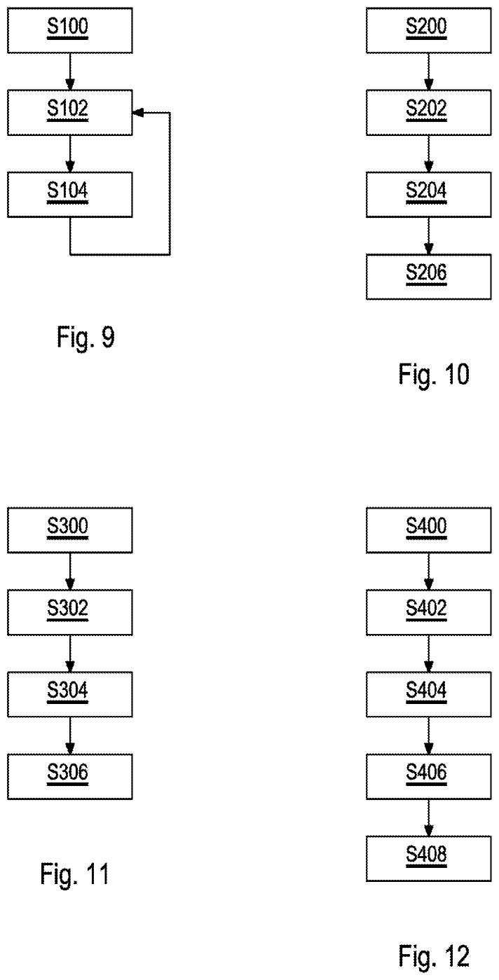

FIG. 9 shows a flowchart of a method for distance measurement of an object according to an exemplary embodiment of the invention. In step S100, the tracking camera 210 of the optical receiver 250 is calibrated, followed by step S102, in which a measurement of an image of the object to be measured takes place on the camera image of the tracking camera 210. Following this, the telescope mounting 510 is aligned in step S104 by means of coordinates converted from the measurement of the image. Subsequently, steps S102 and S104 are repeated as long as the converted coordinates do not undershoot a specified deviation from a target position.

FIG. 10 shows a flowchart of a method for aligning a laser beam onto an object according to an exemplary embodiment of the invention. The focusing of the transmitter camera 116 onto the laser beam 130 is checked and the focus position of the laser beam 130, reflected back by a retroreflector 122, in the transmitter camera 116 is determined in step S200. Subsequently, a motor position in relation to the focus position is determined in step S202. Afterward, a position of at least one object is observed and the object position of the depicted object in the transmitter camera 116 is determined after removal of the retroreflector 122 and temporary blocking of the laser beam 130 in step S204, followed by the conversion of the object position into the motor position in step S206.

FIG. 11 shows a flowchart of a method for determining an object distance according to an exemplary embodiment of the invention. A point in time of an emission of a laser pulse onto an object is determined by an event timer in step S300. Afterward, a point in time upon detection of a photon, particularly of the laser pulse reflected back from the object to be measured, is determined by an assigned detector 218 in step S302. Subsequently, the points in time are transferred to an evaluation unit, particularly a control computer 512, in step S304. Finally, the measured values of emission and detection are correlated.

FIG. 12 shows a flowchart of a method for data evaluation according to an exemplary embodiment of the invention. In step S400, the device 500 is calibrated by means of a distance measurement from an object with a known distance. Points in time of the emission of laser pulses and the receipt of signals are correlated in step S402. Subsequently, an expected delay time to an object to be examined is compared to a delay time measured thereon in step S404, followed by extracting correlated data in step S406. Finally, an averaging of the distance measurements on the object to be examined is carried out in step S408.
100 Laser
101 Laser collimator
102 Starter diode
103 Mirror
104 Energy regulation unit
105 Beam splitter
106 Energy-control unit
107 Mirror
108 Mirror
109 Mirror
110 Aperture
111 Mirror
112 Beam expansion unit
114 Movable mirror
116 Transmitter camera
118 Beam splitter
120 Transmitter telescope/beam expander
122 Retroreflector
124 Carrier plate
125 Broad side
130 Laser beam
150 Optical transmitter
200 Receiving telescope
202 Primary mirror
204 Output mirror
206 Beam splitter
208 Mirror
210 Tracking camera
212 Optical relay unit
214 Bandpass filter
216 Optical fiber
218 Detector
220 Carrier plate
230 Incident light beam
250 Optical receiver
500 Device
506 Azimuth axis
507 Swivel base
508 Elevation axis
509 Rotary shaft
510 Telescope mounting
512 Control computer
514 Control electronics
516 Antenna mount
518 Support unit (with breadboards)
520 Base segment
522 Optical segment
530 Cover
532 Cover
534 Cover
536 Cover
538 Viewing window

1. A device for satellite laser distance measurement having a base segment and an optical segment supported by the base segment, which has a telescope mounting with an azimuth axis and an elevation axis, wherein a transmitter telescope and a receiving telescope as well as a laser coupled to the transmitter telescope are arranged on the telescope mounting.

2. The device according to claim 1, wherein the telescope mounting has a swivel base with the azimuth axis and a rotary shaft with the elevation axis, about which the telescopes can be swiveled synchronously with one another, and the laser can be swiveled synchronously with the transmitter telescope.

3. The device according to claim 1, wherein a carrier plate of a support unit extends between the two telescopes spaced apart from the elevation axis.

4. The device according to claim 3, wherein the support unit comprises the carrier plate, which is arranged parallel to the elevation axis, as well as at least one further carrier plate, which is arranged parallel to the azimuth axis, wherein the two carrier plates are rigidly connected to each other, wherein the transmitter telescope and the further carrier plate are connected to each other.

5. The device according to claim 1, wherein the telescope mounting has an optical transmitter coupled to the transmitter telescope and an optical receiver coupled to the receiving telescope, wherein the optical transmitter is attached to the one carrier plate and the optical receiver is attached to the further carrier plate.

6. The device according to claim 5, wherein the optical transmitter comprises one or more of the following components:
a laser energy regulation unit, with a beam attenuation unit;
a laser energy control unit, with a beam splitter and/or a measuring head for energy and/or power;
an aperture, a mechanical aperture;
a variable beam expansion unit;
a beam direction regulation unit, including a movable mirror;
a beam splitter;
a transmitter camera, including a transmitter camera with image-generating optics;
a starter diode;
at least one mirror;
at least one retroreflector.

7. The device according to claim 5, wherein the optical receiver comprises one or more of the following components:
a beam splitter for splitting the radiation received by the receiving telescope into visible light and infrared light;
a tracking camera in the focus of the receiving telescope;
an optical relay unit, which is provided as further imaging optics;
a bandpass filter;
a detector and/or an optical fiber for supplying the received signals.

8. The device according to claim 1, wherein the laser has radiation in the near-infrared range, particularly IR-B with a wavelength between 1500 nm and 1750 nm.

9. The device according to claim 1, wherein the laser has laser pulses with a pulse length in the range of 0.5 picoseconds to 100 nanoseconds, with a pulse energy of 1 μJ to 1 mJ.

10. The device according to claim 1, wherein the base segment contains one or more of the following components:
a control computer;
control electronics, with an event timer and a trigger generator.

11. The device according to claim 1, wherein the optical segment has at least one cover; wherein the transmitter telescope, the receiving telescope, and the carrier plate have separate covers.

12. The device according to claim 11, wherein an interior of the at least one cover of the optical segment is climate-controlled, wherein a climate-control unit is arranged in the base segment.

13. A method for satellite laser distance measurement having a device, comprising base segment and an optical segment supported by the base segment, which has a telescope mounting, with an azimuth axis and elevation axis, wherein a transmitter telescope and a receiving telescope as well as a laser coupled to the transmitter telescope are arranged on the telescope mounting, wherein the laser also moves synchronously with the transmitter telescope upon a movement of the transmitter telescope.

14. The method according to claim 13, wherein a distance measurement of an object takes place with the following steps:
calibrating a tracking camera of the optical receiver;
measuring an image of the object to be measured on the camera image of the tracking camera;
aligning the telescope mounting by means of coordinates converted from measurement of the image;
repeating steps (ii) and (iii) as long as the converted coordinates have a predetermined deviation from a target position.

15. The method according to claim 13, wherein an alignment of a laser beam on an object takes place with the following steps:
checking the focus of the transmitter camera onto the laser beam and determining the focus position, in the transmitter camera, of the laser beam reflected back by a retroreflector;
determining a motor position in relation to the focus position;
observing a position of at least one object and determining the object position of the depicted object in the transmitter camera after removing the retroreflector and temporary blocking of the laser beam;
converting the object position into the motor position.

16. The method according to claim 13, wherein an object distance is determined with the following steps:
determining a point in time of an emission of a laser pulse onto an object by means of an event timer;
determining a point in time, by means of an assigned detector, upon detection of a photon, of a laser pulse reflected back from the object to be measured;
transferring the points in time to an evaluation unit, including a control computer;
correlating the measured values of emission and detection.

17. The method according to claim 13, wherein data evaluation takes place with the following steps:
calibrating the device by means of measuring the distance from an object with a known distance;
correlating points in time of the emission of laser pulses and of the receipt of signals;
comparing an expected delay time to an object to be examined to a delay time measured thereon;
extracting correlated data;
averaging the distance measurements on the object to be examined.
